(19) United States
(12) Patent Application Publication
(10) Pub. No.: US 2025/0145753 A1
(43) Pub. Date: May 8, 2025

(54) PERFLUOROPOLYETHER POLYMERS COMPRISING PENDANT FUNCTIONAL GROUPS

(71) Applicant: SOLVAY SPECIALTY POLYMERS ITALY S.P.A., Bollate (Milano) (IT)

(72) Inventors: Michela Bea, Castronno (VA) (IT); Andrea Lotierzo, Brugherio (MB) (IT)

(73) Assignee: SOLVAY SPECIALTY POLYMERS ITALY S.P.A., Bollate (Milano) (IT)

(21) Appl. No.: 18/723,178

(22) PCT Filed: Dec. 15, 2022
(86) PCT No.: PCT/EP2022/086028

§ 371 Date: Jun. 21, 2024

(30) Foreign Application Priority Data
Dec. 21, 2021 (EP) 21216316.6

(51) Int. Cl. C08F 283/06; C08L 51/08

(52) U.S. Cl. CPC C08F 283/06; C08L 51/08

(57) ABSTRACT

The present patent application relates to perfluoropolyether polymers comprising functionalized pendant groups along the perfluoropolyether backbone that are obtained from the reaction of a peroxidic perfluoropolyether with a functionalized perfluorinated unsaturated ether.

### CROSS-REFERENCE TO RELATED PATENT APPLICATIONS

This application claims priority filed on 21 Dec. 2021 in EUROPE with Nr 21216316.6, the whole content of this application being incorporated herein by reference for all purposes.

### TECHNICAL FIELD

The present patent application relates to new perfluoropolyether polymers comprising functionalized pendant groups along the perfluoropolyether backbone.

### BACKGROUND ART

Among fluorinated polymers, (per)fluoropolyether polymers (PFPEs) are well-known and of great interest for their chemical and physical properties.

PFPE polymers comprising functional groups along the backbone have been disclosed in the art, being useful as reactive intermediate compounds.

Perfluoropolyether polymers obtained from the reaction of polyperoxidic perfluoropolyether and fluorinated olefin in the presence of U.V. radiation have been disclosed in U.S. Pat. No. 4,500,739 (Montedison S.p.A., Feb. 19, 1985).

U.S. Pat. No. 6,403,539 (Ausimont S.p.A., Jun. 11, 2002) discloses perfluoropolyether polymers containing sulphonyl fluoride groups pending along the backbone. However, the presence of the peroxidic groups is not desired for safety concerns.

Polyfunctional (per)fluoropolyether polymers have been further disclosed in U.S. Pat. No. 5,719,259 (E.I. Du Pont de Nemours and Company, Feb. 17, 1998), U.S. Pat. No. 4,853,097 (Ausimont S.r.l., Aug. 1, 1989), U.S. Pat. No. 5,104,911 (Ausimont S.r.l., Apr. 14, 1992).

US 2011/0230631 (Solvay Solexis S.p.A, Sep. 22, 2011) discloses (per)fluoropolyethers comprising at least one (per)fluoropolyoxyalkylene chain comprising at least one recurring unit of formula —CF₂—CF(CF₂O—SO₂F)—O—, wherein fluorosulfate group in brackets is a pendant group, which is subsequently reacted with a nucleophilic agent to provide functional groups, such as notably carboxylic acid, acyl fluoride, amide and esters.

CN 103724559 (ZHONGHAO CHENGUANG RES INST CHEMICAL IND, Apr. 16, 2014) discloses a method comprising placing the perfluoropolyether peroxide prepared by a photo-oxidation method in an inert fluorine-containing solvent, introducing perfluoro-olefin under an ultraviolet irradiation condition, and reacting the perfluoro-olefin with the peroxide to form a stable perfluoropolyether compound.

WO 2019/048394 (Solvay Specialty Polymers Italy S.p.A., Mar. 14, 2019) discloses polyfunctional perfluoropolyether derivatives including a plurality of ionisable groups selected from the group consisting of —SO₃Xa, —PO₃Xa and —COOXa, wherein Xa is H, ammonium group or a monovalent metal.

### SUMMARY OF INVENTION

The Applicant developed new perfluoropolyether polymers that can be obtained via the insertion of at least one asymmetric olefin along the perfluoropolyether backbone.

Thus, in a first aspect, the present invention relates to a block copolymer [copolymer (P)] comprising a first and a second perfluoropolyether chain [PFPE chain] each having two chain ends, wherein the first chain end of each one of said first and second PFPE chain is a chain end of copolymer (P) and each one comprises a group selected from a perfluorinated linear or branched alkyl chain comprising from 1 to 6 carbon atoms and —C(═O)F, and the second chain ends of said first and second PFPE chain are bonded to each other via a block of formula (I):

-[A-B]_{z}— (I)
wherein
z is an integer from 1 to 100,
(A) is a PFPE chain, and
(B) is at least one group of formula (II):

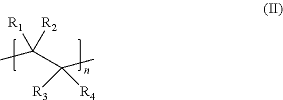

wherein
n is an integer from 1 to 5, preferably from 1 to 2;
R₁ to R₄, each independently, is selected in the group comprising, preferably consisting of, —F, perfluorinated linear or branched alkyl chain having from 1 to 6 carbon atoms, and group of formula (III):

—R₁₀—(X)_{b} (III)
wherein
R₁₀ is a linear or branched perfluoroalkyl chain comprising from 1 to 12 carbon atoms, preferably containing at least one oxygen atom,
X is a functional group, preferably selected from: —COOH, —COF, —CN, —Br and —CONH₂; and
b is an integer equal to 1 or 2;
wherein
   in said formula (I), said (A) and (B) are statistically (randomly) disposed;
   in formula (II), at least one, preferably one, of R₁ to R₄ is group of formula (III); and
   the total number of said groups B in said copolymer (P) is from 1 to 100.

In a second aspect, the present invention relates to a process [process (P)] for the manufacture of copolymer (P) as defined above.

Advantageously, copolymer (P) of the present invention is prepared via process (P) comprising
(a) contacting:
   at least one perfluoropolyether polymer comprising peroxidic groups [PFPE peroxy];
   at least one perfluorinated compound of formula (X-p):

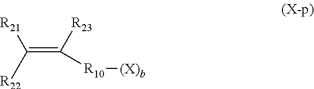

wherein
each of R₂₁ to R₂₃ is independently —F or perfluorinated linear or branched alkyl chain having from 1 to 6 carbon atoms,
R₁₀, X and b are as defined above for formula (III);
(b) letting said PFPE peroxy and said compound of formula (X-p) react in the presence of UV radiation or under heating.

In the process (P) according to the present invention, the amount of the at least one perfluorinated compound of formula (X-p) can be properly selected in order to provide a copolymer (P) characterized by either a low or a high content of pendant functional groups along the backbone of said copolymer (P).

In a further aspect, the present invention relates to copolymer (P) obtained via process (P) as described above.

While purification steps can be performed at the end of said process (P), it will be clear to those skilled in the art that the copolymers (P) according to the present invention are obtained at the end of process (P) as a mixture.

Thus, in a further aspect, the present invention relates to a mixture [mixture (P)] comprising two or more copolymers (P) as defined above.

It will be clear to those skilled in the art that mixture (P) is obtained via process (P) as described above.

Advantageously, said mixture (P) can be subjected to one or more purification steps (also referred to as “fractionation” steps), thus obtaining separate copolymers (P) characterized by different number average molecular weights as measured by ¹⁹F-NMR and/or functionality (F), preferably from 3 to 102.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “perfluoropolyether” and, when used as substantive, is intended to mean either the singular or the plural form, depending on the context;
the term “functionality (F)” is intended to indicate the number of functional groups in the copolymer according to the present invention, which includes both the functional groups deriving from group (X) as represented in formula (II) and (X-p) and the functional groups at each chain end of copolymer (P).

In copolymer (P), said first chain end of each one of said first and second PFPE chains can be equal or different from each other and are selected from a perfluorinated alkyl chain comprising 1 to 3 carbon atoms and —C(═O)F.

According to a preferred embodiment, one of said first chain ends of each one of said first and second PFPE chains comprises a group —C(═O)F and the other chain end comprises a perfluorinated alkyl chain comprising from 1 to 3 carbon atoms.

Preferably, in copolymer (P), said at least one PFPE chain (A) is bonded to one chain end and/or to said at least one group (B) via a sigma bond or a group —(C)— selected from —CF₂—, —CF₂CF₂— or —O—.

Preferably, in copolymer (P), said at least one group (B) is bonded to one chain end and/or to said at least one PFPE chain (A) via a sigma bond or a group —(C)— as defined above.

Preferably, in said copolymer (P), each of said PFPE chain is a fully fluorinated chain [chain (R_{f})] comprising, preferably consists of, repeating units R^{o}, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}-I)
wherein
   X¹ is independently selected from —F and —CF₃,
   X², X³, equal or different from each other and at each occurrence, are independently —F, —CF₃, with the proviso that at least one of X is —F;
   g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (R_{f}-IIA)
wherein:
   a1 and a2 are independently integers ≥0 such that the number average molecular weight is between 400 and 100,000, preferably between 400 and 50,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b}]— (R_{f}-IIB)
wherein:
b1, b2, b3, b4, are independently integers ≥0 such that the number average molecular weight is between 400 and 100,000, preferably between ₄400 and 50,000; preferably each of b1, b2, b3, b4 are >0;

—[(CF₂CF₂O)_{c1}(CF₂O)_{c2}(CF₂(CF₂)_{cw}CF₂O)_{c3}]— (R_{f}-IIC)
wherein:
cw=1 or 2;
c1, c2, and c3 are independently integers ≥0 chosen so that the number average molecular weight is between 400 and 100,000, preferably between 400 and 50,000; preferably c1, c2 and c3 are all >0, with the ratio c3/(c1+c2) being generally lower than 0.2.

Still more preferably, chain (R_{f}) complies with formula (R_{f}-III) here below:

—[(CF₂CF₂O)ₐ₁(CF₂O)ₐ₂]— (R_{f}-III)
wherein:
   a1, and a2 are integers >0 such that the number average molecular weight is between 400 and 100,000, preferably between 400 and 50,000, with the ratio a1/a2 being generally between 0.1 and 10, more preferably between 0.2 and 5.

Preferably, in formula (II), at least one of substituents R₁ to R₄ is a group of formula (III) and the other substituents are each independently selected from —F or a perfluorinated alkyl chain having from 1 to 3 carbon atoms, more preferably —F or a —CF₃.

Preferably, in said formula (III), b is 1.

Preferably, in said formula (III), said R₁₀ is a linear or branched perfluoroalkyl chain comprising from 1 to 9, more preferably from 1 to 6, carbon atoms and one or two oxygen atom(s).

Preferably, in formula (III), said R₁₀ complies with the following formula:

—(CF₂)_{d}O—R_{CF}— (R₁₀-i)
wherein
d is zero or 1 and
R_{CF} is a linear or branched perfluoroalkyl chain comprising from 1 to 3 carbon atoms or a linear or branched perfluoroalkyl chain comprising from 1 to 6 carbon atoms and at least one oxygen atom.

More preferably, said R_{CF} is a linear or branched perfluoroalkyl chain comprising from 1 to 5 carbon atoms, optionally interrupted by one oxygen atom.

Copolymers (P) according to the present invention can be advantageously prepared via the claimed process (P), which can be easily scaled up.

Before step (a), the PFPE peroxy can be subjected to partial reduction of the peroxid bonds, for example by chemical reduction or UV treatment or thermal treatment.

Preferably, said PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain [chain (R_{f})] comprising, preferably consisting of, repeating units (R^{o}) being independently selected from the group consisting of formulae (i) to (v) as above defined and having a peroxidic content (PO), defined as grams of active oxygen (Mw=16) in 100 g of PFPE peroxy between 0.1 and 4, preferably between 0.1 and 3.5.

Preferably, in said PFPE peroxy, chain (R_{f}) complies with formulae (Rf-I), or (Rf-IIA), (Rf-IIB), (Rf-IIC) or (Rf-III) as defined above.

According to a particularly preferred embodiment, said at least one compound of formula (X-p) is selected from

CF₂═CFCF₂OCF₂CF₂COOH

CF₂═CFOCF₂COOH

CF₂═CFO(CF₂)₅COOH

CF₂═CFOCF₂CF₂OCF₂COOH

CF₂═CFOCF₂CF₂COOH

CF₂═CFCF₂OCF₂CF₂COF

CF₂═CFOCF₂COF

CF₂═CFO(CF₂)₃OCF(CF₃)COF

CF₂═CFO(CF₂)₅COF

CF₂═CFOCF₂CF(CF₃)OCF₂CF₂CN

CF₂═CFOCF₂CN

CF₂═CFO(CF₂)₅CN

CF₂═CFO(CF₂)₃OCF(CF₃)CN

CF₂═CFCF₂OCF₂CF₂CN

CF₂═CFOCF₂CF₂Br

CF₂═CFCF₂OCF₂CF₂Br

CF₂═CFOCF₂CF(CF₃)OCF₂CF₂Br

CF₂═CFCF₂OCF₂CF₂CONH₂

CF₂═CFOCF₂CONH₂

CF₂═CFOCF₂CF₂CONH₂.

In step (a), the amount of said compound (X-p) is not limited, it can advantageously be selected by the person skilled in the art on the basis of both the amount of the PFPE peroxy, as well as its peroxidic content, and the final polymer desired. For example, the equivalents of double bonds of said compound (X-p) to the equivalents of peroxidic groups can range from 1:100 to 5000:100. As will be understood by those skilled in the art, said compound (X-p) can be the solvent (i.e., in a very large excess) and separated by copolymer (P) of the invention at the end of the reaction, for example via distillation.

Step (a) of process (P) can be advantageously performed by contacting said PFPE peroxy with one compound of formula (X-p). According to this embodiment, group (B) in copolymer (P) will be one group of formula (II) as defined above.

Alternatively, said step (a) can be performed by contacting said PFPE peroxy with two or more compounds of formula (X-p). According to this embodiment, group (B) in copolymer (P) will be two or more groups each of formula (II) as defined above.

In other words, in this embodiment, said block (I) complies with formula (I-a):

-[A-(B1)ₙ₁-(B2)ₙ₂-(Bx)ₙₓ]_{z}- (I-a)
wherein
each of z and A are as defined above,
B1 derives from a first compound (X-p), B2 derives from a second compound (X—P) and Bx derives from x^{th} compound (X-p), wherein B1, B2 and Bx are randomly disposed within block (I) and each of n1, n2 and nx is zero or an integer from 1 to 5, preferably 1 or 2, provided that at least two of n1, n2 and nx are different from zero.

Step (a) and step (b) can be performed in the presence of a fluorinated solvent. Preferably said fluorinated solvent is selected in the group comprising: perfluorocarbons, hydrofluorocarbons, perfluoropolyethers, hydrofluoro-polyethers.

Preferably, step (b) is performed in the presence of UV radiation for a time from 2 to 150 hours, more preferably from 5 to 100 hours.

Preferably, step (b) is performed in the presence of UV radiation at a temperature from −60° C. to +150° C., more preferably from −20° C. to +100° C. and even more preferably from 0° C. to 60° C.

As an alternative, step (b) can be performed under thermal treatment, preferably by heating at a temperature from 150° C. to 250° C.

Preferably, said step (b) is performed in an inert atmosphere.

Advantageously, the functional groups introduced as pendant groups along the backbone of said copolymer (P), such as notably —COOH, —COF, —CN, —Br and —CONH₂, as well as the functional groups at the chain ends of copolymer (P), such as notably —COF, can be properly reacted to obtain other different functional groups.

The expression “can be reacted” is intended to indicate that such functional groups can for example be salified, hydrolyzed or undergo a different chemical reaction to provide functional group(s) endowed with the desired reactivity, taking into consideration the final use of copolymer (P).

In another aspect, the present invention relates to a block copolymer [copolymer (P_{F})] comprising a first and a second perfluoropolyether chain [PFPE chain] each having two chain ends, wherein the first chain end of each one of said first and second PFPE chain is a chain end of copolymer (P_{F}) and each one comprises a group selected from: a perfluorinated linear or branched alkyl chain having from 1 to 6 carbon atoms; —COOH and salts thereof with an organic cation, preferably onium cation, more preferably ammonium, or an inorganic cation, preferably an alkaline metal, more preferably Na⁺, K⁺; —COOR wherein R is a linear or branched alkyl chain comprising from 1 to 6 carbon atoms, preferably from 1 to 3 carbon atoms, more preferably 1 carbon atoms; —COF; —CONH₂; —CON(R₁₀₀)(R₁₀₁) wherein each of R₁₀₀ and R₁₀₀ have the same meanings defined for R; —(R)_{c}OH with c being 0 or 1 and R being as defined above; —C(O)—O—C(O)R with R being as defined above;
with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprises a perfluorinated linear or branched alkyl chain having from 1 to 6 carbon atoms or —COF;
and the second chain ends of said first and second PFPE chain are bonded to each other via a block of formula (I):

-[A_{F}-B_{F}]_{z}— (I)
wherein
z is an integer from 1 to 100,
(A) is a PFPE chain, and
(B) is at least one group of formula (II):

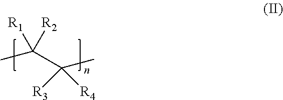

wherein
n is an integer from 1 to 5, preferably from 1 to 2;
R₁ to R₄, each independently, is selected in the group comprising, preferably consisting of, —F, perfluorinated linear or branched alkyl chain having from 1 to 6 carbon atoms, and group of formula (III):

—R₁₀—(X)_{b} (III)
wherein
R₁₀ is a linear or branched perfluoroalkyl chain comprising from 1 to 12 carbon atoms, optionally containing one or more oxygen atoms, X is a functional group, preferably selected from: —COOH and salts thereof with an organic cation, preferably onium cation, more preferably ammonium, or an inorganic cation, preferably an alkaline metal, more preferably Na⁺, K⁺; —COOR with R being as defined above; —COF; —CON(R₁₀₀)(R₁₀₁) wherein each of R₁₀₀ and R₁₀₀ are a hydrogen atom or have the same meanings defined for R; —(R)_{c}OH with c being 0 or 1 and R being as defined above; —C(O)—O—C(O)R with R being as defined above; —Br; —CN; and
b is an integer equal to 1 or 2;
wherein
   in said formula (I), said (A) and (B) are statistically (randomly) disposed;
   in formula (II), at least one, preferably one, of R₁ to R₄ is group of formula (III); and
   the total number of said groups B in said copolymer (P_{F}) is from 1 to 100.

Advantageously, copolymer (P_{F}) according to the present invention is obtained from process (P) as described above, which further comprises after said step (b), at least one step (c) comprising salification, hydrolyzation, oxidation, reduction or another chemical reaction capable of providing functional group(s) of interest.

The present invention further encompasses copolymer (P_{F}) obtained at the end of step (c) of process (P).

In another aspect, the present invention relates to a mixture [mixture (P_{F})] comprising two or more copolymers (P_{F}) as defined above.

While process (P) according to the present invention can be controlled, and purification steps can be performed after step (b) or step (c) of process (P), mixtures of one or more copolymers (P) or copolymers (P_{F}) are typically obtained. Said mixtures can further contain the PFPE peroxy used as starting material and/or mixtures of copolymers (P) containing peroxy groups [copolymer (P_{O—O})] and/or mixtures of copolymers (P_{F}) containing peroxy groups [copolymers (P_{F—O—O})] can be obtained.

In another aspect, the present invention related to a mixture [mixture (M1)] comprising at least one copolymer (P) as defined above, and at least one of said PFPE peroxy used as starting material and/or one or more of said copolymers (P_{O—O}).

In another aspect, the present invention relates to a mixture [mixture (M2)] comprising at least one copolymer (P_{F}) as defined above, and at least one of at least one of said copolymer (P) as defined above, said PFPE peroxy used as starting material, said one or more copolymers (P_{O—O}), and/or said one or more copolymers (P_{F—O—O}).

Advantageously, said copolymer (P_{O—O}) and/or said copolymer (P_{F—O—O}) can be isolated and used as intermediate in other processes.

While the amount of peroxy groups that can be present in the mixture containing copolymer (P) or copolymer (P_{F}) of the present invention can be up to 99% based on the amount of the starting peroxy groups in the PFPE peroxy, depending on the final application the amount of said peroxy groups can be properly adjusted for example up to 95, 90, 85, 80, 75, 70, 65, 60, 55, 50, 45, 40, 35, 30, 25, 20, 15, 10, 5%.

More preferably, the amount of said peroxy groups is up to 1, even more preferably up to 0.5% and still more preferably up to 0.1%.

In another aspect, the present invention relates to a block copolymer [copolymer (P_{O—O})] comprising a first and a second perfluoropolyether chain [PFPE chain] complying with formula A or (Rf_{O—O}), wherein A is as defined above and (Rf_{O—O}) is a repeating units complying with any one of formulae (i) to (v) as defined above for (R^{o}) and having a peroxidic content (PO), defined as grams of active oxygen (Mw=16) in 100 g of PFPE peroxy between 0.1 and 4, preferably between 0.1 and 3.5, each of said first and second PFPE chain having two chain ends, wherein the first chain end of each one of said first and second PFPE chain is a chain end of copolymer (P) and each one comprises a group selected from: a perfluorinated linear or branched alkyl chain having from 1 to 6 carbon atoms; —COOH and salts thereof with an organic cation, preferably onium cation, more preferably ammonium, or an inorganic cation, preferably an alkaline metal, more preferably Na⁺, K⁺; —COOR wherein R is a linear or branched alkyl chain comprising from 1 to 6 carbon atoms, preferably from 1 to 3 carbon atoms, more preferably 1 carbon atoms; —COF; —CONH₂; —CON(R₁₀₀)(R₁₀₁) wherein each of R₁₀₀ and R₁₀₀ have the same meanings defined for R; —(R)_{c}OH with c being 0 or 1 and R being as defined above; —C(O)—O—C(O)R with R being as defined above;
and the second chain ends of said first and second PFPE chain are bonded to each other via a block of formula (I_{O—O}):

-[A-B—(Rf_{O—O})]_{z}— (I_{O—O})

wherein z, A, B and (Rf_{O—O}) are as defined above,
wherein
   in formula (I_{O—O}), A, B and (Rf_{O—O}) are statistically (randomly) disposed and
   the total number of said groups B in said copolymer (P_{O—O}) is from 1 to 100.

In a still another embodiment, the present invention relates to a block copolymer [copolymer (P_{F—O—O})] comprising a first and a second perfluoropolyether chain [PFPE chain] complying with formula A or (Rf_{O—O}), wherein A is as defined above and (Rf_{O—O}) is a repeating units complying with any one of formulae (i) to (v) as defined above for (R^{o}) and having a peroxidic content (PO), defined as grams of active oxygen (Mw=16) in 100 g of PFPE peroxy between 0.1 and 4, preferably between 0.1 and 3.5, each of said first and second PFPE chain having two chain ends, wherein the first chain end of each one of said first and second PFPE chain is a chain end of copolymer (P_{F—O—O}) and each one comprises a group selected from: a perfluorinated linear or branched alkyl chain having from 1 to 6 carbon atoms; —COOH and salts thereof with an organic cation, preferably onium cation, more preferably ammonium, or an inorganic cation, preferably an alkaline metal, more preferably Na⁺, K⁺; —COOR wherein R is a linear or branched alkyl chain comprising from 1 to 6 carbon atoms, preferably from 1 to 3 carbon atoms, more preferably 1 carbon atoms; —COF; —CONH₂; —CON(R₁₀₀)(R₁₀₁) wherein each of R₁₀₀ and R₁₀₀ have the same meanings defined for R; —(R)_{c}OH with c being 0 or 1 and R being as defined above; —C(O)—O—C(O)R with R being as defined above; with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprises a perfluorinated linear or branched alkyl chain having from 1 to 6 carbon atoms or —COF;
and the second chain ends of said first and second PFPE chain are bonded to each other via a block of formula (I_{O—O}):

-[A-B—(Rf_{O—O})]_{z}— (I_{O—O})
wherein z, A, B and (Rf_{O—O}) are as defined above,
wherein
   in formula (I_{O—O}), A, B and (Rf_{O—O}) are statistically (randomly) disposed and
   the total number of said groups B in said copolymer (P_{F—O—O}) is from 1 to 100.

Should the disclosure of any patents, patent applications, and publications which are incorporated herein by reference conflict with the description of the present application to the extent that it may render a term unclear, the present description shall take precedence.

The invention will be now described in connection with the following examples, whose purpose is merely illustrative and not intended to limit the scope of the invention.

### EXPERIMENTAL SECTION

### Materials

Peroxidic perfluoropolyether oils were obtained by Solvay Specialty Polymers Italy S.p.A., complying with formula

XO—(CF₂CF₂O)ₘ(CF₂O)ₙ(O)ₕ—X′
wherein
X and X′ were —CF₃, —CF₂COF, —COF and having the following properties:
PFPE peroxy (1) Mn=40 900 g/mol; P.O.=1.45%; m/n=1.1
PFPE peroxy (2) Mn=37 800 g/mol; P.O.=1.47%; m/n=1.1
PFPE peroxy (3) Mn=25 000 g/mol; P.O.=1.34%; m/n=1.1
PFPE peroxy (4) Mn=39 000 g/mol; P.O.=1.54%; m/n=1.0
PFPE peroxy (5) Mn=46 000 g/mol; P.O.=1.61%; m/n=1.0
PFPE peroxy (6) Mn=47 000 g/mol; P.O.=1.61%; m/n=1.0
PFPE peroxy (7) Mn=37 000 g/mol; P.O.=1.53%; m/n=1.0

The following were purchased by Anles LTD and used as such:
perfluoroallyl acid (PFAA) CF₂═CFCF₂OCF₂CF₂COOH
perfluoroallyl acyl fluoride (PFAAF) CF₂═CFCF₂OCF₂CF₂COF
perfluorovinyl cyano (8-CNVE) CF₂═CFOCF₂CF(CF₃)OCF₂CF₂CN

Perfluorinated solvents Galden SV70, Galden HT200 and Galden D100 were obtained by Solvay Specialty Polymers Italy S.p.A.

### Methods

¹⁹F-NMR-Varian Mercury 200 MHz spectrometer working for the ¹⁹F nucleus was used to obtain the structure, molecular weight, chain end composition of the perfluoropolyether oils. The ¹⁹F-NMR spectrum was obtained on pure samples using CFCl₃ as internal reference.

The peroxidic content (PO) was expressed as grams of peroxidic oxygen per 100 g of polymer. The analysis of the peroxide content was carried out by iodometric titration using a Mettler DL40 device equipped with platinum electrode. The sensitivity limit for the PO determination was 0.0002%.

### Example 1—Preparation of Poly-Carboxylic Perfluoropolyether by Thermal Route

150 g of peroxidic perfluoropolyether oil [PFPE (1)], 3.4 g of PFAA and 100 g of Galden® HT200 were introduced in a flask equipped with a magnetic stirrer and a thermometer. The mixture was heated at 80° C. to homogenize and then the temperature was progressively increased from 160° C. to 230° C. in a N₂ atmosphere for 14 hours. At the end, the product was maintained at 240° C. in vacuum for 1 hour. ¹⁹F-NMR analysis of the product confirmed the complete removal of peroxide units and unreacted olefin. The structure found was:

X—O—(CF₂CF₂O)ₘ(CF₂O)ₙ[CF₂CF(CF₂OCF₂CF₂COOH)]ₐ—X′
with m/n=1.1,
a=3.3 as average,
X and X′=—CF₃, —CF₂COF and
number average molecular weight (Mn)=43 300 g/mol.

### Example 2—Preparation of Poly Cyano Perfluoropolyether by Photochemical Route

A 800 mL cylindrical photochemical reactor was equipped with a high pressure mercury lamp model HANAU TQ150. The reactor was equipped with a thermocouple and a condenser.

250 g of peroxidic perfluoropolyether oil [PFPE (2)] were charged with 680 g of Galden® SV70 and 8.6 g of 8-CNVE and were stirred to have an homogenous mixture. The UV lamp was switched on. The reactor was kept at about 10° C. with an ice/water mixture during the reaction time. The reaction was conducted in N₂ inert atmosphere.

After 96 hours, the lamp was switched off and the reaction mixture was recovered. Then, the solvent was distilled at 70° C. under vacuum. ¹⁹F-NMR analysis of the product confirmed the complete removal of peroxide units and the structure:

XO—(CF₂CF₂O)ₘ(CF₂O)ₙ(CF₂CFO(CF₂CF(CF₃)OCF₂CF₂CN))ₐ—X′
where m/n=1.1,
a=2.5 as average,
X and X′=—CF₃, —CF₂COF and
number average molecular weight (Mn)=39 500 g/mol.

The introduction of the —CN functional groups was also confirmed by FT-IR spectroscopy measurements, confirming the presence of the peak at 2269 cm⁻¹.

### Example 3—Preparation of Poly-Carboxylic Perfluoropolyether by Photochemical Route

A 1000 mL cylindrical photochemical reactor was equipped with a high pressure mercury lamp model HANAU TQ150. The reactor was equipped with a thermocouple and a condenser.

780 g of peroxidic perfluoropolyether oil [PFPE (3)] were charged in the reactor with 776 g of PFAA and the mixture was stirred to homogenize. The reaction was conducted in N₂ atmosphere. The UV lamp was switched on. The reactor was kept at about 20° C. with an ice/water mixture during the reaction time.

After 36 hours, the lamp was switched off and the reaction mixture was transferred in a flask equipped with a magnetic stirrer and thermometer. The residual PO and the unreacted olefin were removed by heating the mixture from 160 to 240° C. over 11 hours.

¹⁹F-NMR analysis of the product confirmed the complete removal of peroxide units and unreacted olefin.

The acyl fluoride end groups were converted to the corresponding carboxylic acids by hydrolysis, according to the following procedure.

The product was dissolved in 820 g of Galden® SV70 and 300 g of 20% HCl in water were added. The mixture was heated at 80° C. for 2 h and then the two phases separated at room temperature. The fluorinated phase was washed twice with 300 mL of HCl 20% and then distilled at 120° C. under vacuum to remove water and HCl traces. The final product (794 g) was analyzed with ¹⁹F-NMR, which confirms that all the acyl fluoride groups were converted into corresponding carboxylic acid groups.

¹⁹F-NMR analysis confirmed the desired structure:

X—O—(CF₂CF₂O)ₘ(CF₂O)ₙ[CF₂CF(CF₂OCF₂CF₂COOH)]ₐ—X′
where
m/n=1.1,
a=18 as average,
X and X′=—CF₃, —CF₂COOH.

### Example 4—Preparation of Poly Carboxylic Perfluoropolyether with Low Equivalent Weight by Thermal Route

750 g of peroxidic perfluoropolyether oil [PFPE (4)] and 750 g of PFAA were introduced in a flask equipped with a magnetic stirrer and thermometer. The mixture was heated at 80° C. to homogenize and then the temperature was increased from 160° C. to 220° C. over 25 hours. At the end, the product was maintained at 220° C. in vacuum for 1 hour.

The acyl fluoride groups were converted to the corresponding carboxylic acids by hydrolysis with water.

The product was stirred with 300 g of distilled water at room temperature for 4 hours. The fluorinated product was separated from the water phase and washed twice with fresh water. The final product was recovered after drying at 150° C. in vacuum apparatus. The final product was analyzed with ¹⁹F-NMR, which confirmed that all the acyl fluoride groups were converted into corresponding carboxylic acid groups and that all the peroxide bonds were successfully removed.

The structure was:

XO—(CF₂CF₂O)ₘ(CF₂O)ₙ[CF₂CF(CF₂OCF₂CF₂COOH)]ₐ—X′
where m/n=1.0,
a=24 as average,
X and X′=—CF₃, —CF₂COOH.

### Example 5—Preparation of Poly Acyl Fluoride Perfluoropolyether by Photochemical Route

A 800 mL cylindrical photochemical reactor was equipped with a high pressure mercury lamp model HANAU TQ150. The reactor was equipped with a thermocouple and a condenser.

Under N₂ inert atmosphere, 207 g of the peroxidic perfluoropolyether oil [PFPE (5)] were charged in the reactor with 554 g of Galden® D100 as solvent and 199 g of PFAAF. The mixture was well stirred to homogenize. The UV lamp was switched on. The reactor was kept at about 20° C. with an ice/water mixture during the reaction time.

After 25 hours, the lamp was switched off and the reaction mixture was recovered under dry N₂ atmosphere in a flask equipped with a magnetic stirrer and a thermometer. The residual PO and the unreacted olefin were removed by heating the flask from 130° C. to 230° C. At the end, the last traces of PO were removed at 230° C. under vacuum.

¹⁹F-NMR analysis confirmed the complete removal of peroxide units and unreacted olefin and the structure:

XO—(CF₂CF₂O)ₘ(CF₂O)ₙ[CF₂CF(CF₂OCF₂CF₂COF)]ₐ—X′
where m/n=1.0,
a=33 as average,
X and X′=—CF₃, —CF₂COF and
number average molecular weight (Mn)=40 200 g/mol.

### Example 6—Preparation of Poly Cyano Perfluoropolyether by Photochemical Route

A 1000 mL cylindrical photochemical reactor was equipped with a high pressure mercury lamp model HANAU TQ150. The reactor was equipped with a thermocouple and a condenser.

352 g of that peroxidic perfluoropolyether oil [PFPE (6)] were charged with 1180 g of Galden® D100 and 212.8 g of 8-CNVE and were stirred to have an homogenous mixture. The UV lamp was switched on. The reactor was kept at about 20° C. with an ice/water mixture during the reaction time. The reaction was conducted in N₂ inert atmosphere

After 56 hours, the lamp was switched off and the reaction mixture was recovered. The mixture was introduced in a flask and the solvent and the unreacted olefin were distilled at 120° C. under vacuum.

¹⁹F-NMR analysis of the product confirmed the complete removal of peroxide units and unreacted olefin and the structure:

XO—(CF₂CF₂O)ₘ(CF₂O)ₙ[CF₂CFOCF₂CF(CF₃)OCF₂CF₂CN)]a-X′
where
m/n=1.0,
a=52 as average,
X and X′=—CF₃, —CF₂COF and
number average molecular weight (Mn)=56 400 g/mol.

The introduction of —CN functional groups was also confirmed by FT-IR spectroscopy measurements by confirming the presence of the peak at 2269 (sharp) cm⁻¹.

### Example 7—Preparation of Poly-Carboxylic Perfluoropolyether by Photochemical Route

250 g of peroxidic perfluoropolyether oil [PFPE (7)] were charged in the reactor with 680 g of Galden® SV70 and 5.7 g of PFAA and the mixture was stirred to homogenize. The reaction is conducted in N₂ inert atmosphere. The UV lamp was switched on. The reactor was kept at about 10° C. with an ice/water mixture during the reaction time.

After 6 hours, the lamp was switched off and the reaction mixture was recovered. The product was introduced in a flask equipped with a magnetic stirrer and submitted to distillation to remove the solvent. After that, the temperature was raised to 240° C. and maintained for 5 hours. The ¹⁹F-NMR of the product confirmed the complete removal of peroxide units.

The acyl fluoride groups were converted to the corresponding carboxylic acids by hydrolysis with water; the product was stirred with 300 g of distilled water at room temperature for 4 hours. The final mass was separated from the water phase and washed twice with fresh water. The final product was recovered after drying at 150° C. in vacuum. The final product was analyzed with ¹⁹F-NMR, which confirms that all the acyl fluoride groups were converted into corresponding carboxylic acid groups.

The structure found was

XO—(CF₂CF₂O)ₘ(CF₂O)ₙ(CF₂CF(CF₂OCF₂CF₂COOH))ₐ—X′,
with Mn=40 400 g/mol
m/n=was 1.0 and
a=3.5 as average value
X and X′=—CF₃, —CF₂COOH.

1. A block copolymer, copolymer (P), comprising a first and a second perfluoropolyether chain, PFPE chain, each having two chain ends, wherein the first chain end of each one of said first and second PFPE chain is a chain end of copolymer (P) and each one comprises a group selected from a perfluorinated linear or branched alkyl chain comprising from 1 to 6 carbon atoms and —C(═O)F, and the second chain ends of said first and second PFPE chain are bonded to each other via a block of formula (I):
-[A-B]_{z}— (I)
wherein
z is an integer from 1 to 100,
(A) is a PFPE chain, and
(B) is at least one group of formula (II): 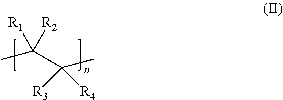
wherein
n is an integer from 1 to 5;
R₁ to R₄, each independently, is selected from the group consisting of, —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms,
X is a functional group; and
b is an integer equal to 1 or 2;
wherein
in said formula (I), said (A) and (B) are statistically (randomly) disposed;
in formula (II), at least one of R₁ to R₄ is group of formula (III); and
the total number of said groups B in said copolymer (P) is from 1 to 100.

2. The copolymer (P) according to claim 1, wherein at least one of the two chain ends comprises a group —C(═O)F and the other chain end comprises a perfluorinated alkyl chain comprising from 1 to 3 carbon atoms.

3. The copolymer (P) according to claim 1, wherein
said at least one block (A) is bonded to one chain end and/or to said at least one block (B) via a sigma bond or a group —(C)— selected from —CF₂—, —CF₂CF₂— or —O—; and/or
said at least one block (B) is bonded to one chain end and/or to said at least one block (A) via a sigma bond or a group —(C)— selected from —CF₂—, —CF₂CF₂— or —O—.

4. The copolymer (P) according to claim 1, wherein each of said PFPE chain is a fully fluorinated chain [chain (R_{f})] comprising repeating units R^{o}, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

5. The copolymer (P) according to claim 1, wherein:
in formula (II), at least one of substituents R₁ to R₄ is a group of formula (III) and the other substituents are each independently selected from —F or a perfluorinated alkyl chain having from 1 to 3 carbon atoms; and/or
in said formula (III), b is 1; and/or
in said formula (III), said R₁₀ is a linear or branched perfluoroalkyl chain comprising 1 to 9 carbon atoms and one or two oxygen atom(s).

6. The copolymer (P) according to claim 5, wherein said R₁₀ complies with the following formula:
—(CF₂)_{d}O—R_{CF}— (R₁₀-i)
wherein
d is zero or 1 and
R_{CF} is a linear or branched perfluoroalkyl chain comprising 1 to 3 carbon atoms or a linear or branched perfluoroalkyl chain comprising 1 to 6 carbon atoms and at least one oxygen atom.

7. The copolymer (P) according to claim 1, wherein block (I) complies with formula (I-a):
-[A-(B1)ₙ₁-(B2)ₙ₂-(Bx)ₙₓ]_{z}- (I-a)
wherein
B1, B2 and Bx are randomly disposed within block (I) and
each of n1, n2 and nx is zero or an integer from 1 to 5, provided that at least two of n1, n2 and nx are different from zero.

8. A mixture, mixture (P), comprising two or more copolymers (P) according to claim 1.

9. A process, process (P), for the manufacture of copolymer (P) according to claim 1, said process comprising
(a) contacting:
at least one perfluoropolyether polymer comprising peroxidic groups, PFPE peroxy;
at least one perfluorinated compound of formula (X-p): 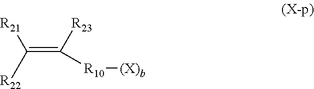
wherein
each of R₂₁ to R₂₃ is independently-F or perfluorinated linear or branched alkyl chain having from 1 to 6 carbon atoms;
and
(b) letting said PFPE peroxy and said compound of formula (X-p) react in the presence of UV radiation or under heating.

10. The process (P) according to claim 9, wherein:
said PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (Rf), comprising repeating units (R^{o}) being independently selected from the group consisting of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain;
and having a peroxidic content (PO), defined as grams of active oxygen (Mw=16) in 100 g of PFPE peroxy between 0.1 and 4;
and/or
said at least one compound of formula (X-p) is selected from:
CF₂═CFCF₂OCF₂CF₂COOH
CF₂═CFOCF₂COOH
CF₂═CFO(CF₂)₅COOH
CF₂═CFOCF₂CF₂OCF₂COOH
CF₂═CFOCF₂CF₂COOH
CF₂═CFCF₂OCF₂CF₂COF
CF₂═CFOCF₂COF
CF₂═CFO(CF₂)₃OCF(CF₃)COF
CF₂═CFO(CF₂)₅COF
CF₂═CFOCF₂CF(CF₃)OCF₂CF₂CN
CF₂═CFOCF₂CN
CF₂═CFO(CF₂)₅CN
CF₂═CFO(CF₂)₃OCF(CF₃)CN
CF₂═CFCF₂OCF₂CF₂CN
CF₂═CFOCF₂CF₂Br
CF₂═CFCF₂OCF₂CF₂Br
CF₂═CFOCF₂CF(CF₃)OCF₂CF₂Br
CF₂═CFCF₂OCF₂CF₂CONH₂
CF₂═CFOCF₂CONH₂
CF₂═CFOCF₂CF₂CONH₂.

11. A block copolymer, copolymer (P_{F}), comprising
a first and a second perfluoropolyether chain [PFPE chain] each having two chain ends, wherein the first chain end of each one of said first and second PFPE chain is a chain end of copolymer (P_{F}) and each one comprises a group selected from: a perfluorinated linear or branched alkyl chain having from 1 to 6 carbon atoms; —COOH and salts thereof with an organic cation or an inorganic cation; —COOR wherein R is a linear or branched alkyl chain comprising from 1 to 6 carbon atoms; —COF; —CONH₂; —CON(R₁₀₀)(R₁₀₁) wherein each of R₁₀₀ and R₁₀₀ have the same meanings defined for R; —(R)_{c}OH with c being 0 or 1; and R being as defined —C(O)—O—C(O)R;
with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprise a perfluorinated linear or branched alkyl chain having from 1 to 6 carbon atoms or —COF;
and the second chain ends of said first and second PFPE chain are bonded to each other via a block of formula (I):
-[A-B]_{z}— (I)
wherein
z is an integer from 1 to 100,
(A) is a PFPE chain, and
(B) is at least one group of formula (II): 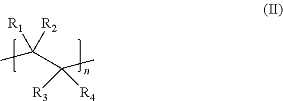
wherein
n is an integer from 1 to 5;
R₁ to R₄, each independently, is selected from the group consisting of —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms, optionally containing one or more oxygen atoms,
X is a functional group, selected from: —COOH and salts thereof with an organic cation or an inorganic cation; —COOR with R being a linear or branched alkyl chain comprising from 1 to 6 carbon atoms; —COF; —CON(R₁₀₀)(R₁₀₁) wherein each of R₁₀₀ and R₁₀₀ are a hydrogen atom or have the same meanings defined for R; —(R)_{c}OH with c being 0 or 1 and R being a linear or branched alkyl chain comprising from 1 to 6 carbon atoms; —C(O)—O—C(O)R with R being a linear or branched alkyl chain comprising from 1 to 6 carbon atoms; —Br; —CN; and
b is an integer equal to 1 or 2;
wherein
in said formula (I), said (A) and (B) are statistically (randomly) disposed;
in formula (II), at least one of R₁ to R₄ is group of formula (III); and
the total number of said groups B in said copolymer (P_{F}) is from 1 to 100.

12. A mixture, mixture (P_{F}), comprising two or more copolymers (P_{F}) according to claim 11.

13. A block copolymer, copolymer (P_{O—O}), comprising
a first and a second perfluoropolyether chain, PFPE chain, complying with formula A or (Rf_{O—O}), wherein A is a PFPE chain and (Rf_{O—O}) is a repeating units complying with any one of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F:
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain;
and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of copolymer (P) and each one comprises a group selected from: a perfluorinated linear or branched alkyl chain having from 1 to 6 carbon atoms; —COOH and salts thereof with an organic cation or an inorganic cation; —COOR wherein R is a linear or branched alkyl chain comprising from 1 to 6 carbon atoms; —COF; —CONH₂; —CON(R₁₀₀)(R₁₀₁) wherein each of R₁₀₀ and R₁₀₀ have the same meanings defined for R; —(R)_{c}OH with c being 0 or 1; —C(O)—O—C(O)R;
and the second chain ends of said first and second PFPE chain are bonded to each other via a block of formula (I_{O—O}):
-[A-B—(Rf_{O—O})]_{z}— (I_{O—O})
wherein
z is an integer from 1 to 100,
(A) is a PFPE chain, and
(B) is at least one group of formula (II): 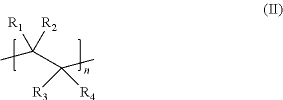
wherein
n is an integer from 1 to 5;
R₁ to R₄, each independently, is selected from the group consisting of, —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms,
X is a functional group; and
b is an integer equal to 1 or 2;
and
wherein
in formula (I_{O—O}), A, B and (Rf_{O—O}) are statistically (randomly) disposed and
the total number of said groups B in said copolymer (P_{O—O}) is from 1 to 100.

14. A mixture, mixture (M1), comprising at least one copolymer (P) according to claim 1, and at least one of PFPE peroxy and/or one or more of copolymer (P_{O—O}),
wherein
the PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (R_{f}), comprising repeating units (R^{o}) being independently selected from the group consisting of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain; and
the copolymer (P_{O—O}) is a block copolymer comprising a first and a second perfluoropolyether chain, PFPE chain, complying with formula A or (Rf_{O—O}), wherein A is a PFPE chain and (Rf_{O—O}) is a repeating units complying with any one of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F:
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain;
and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of copolymer (P) and each one comprises a group selected from: a perfluorinated linear or branched alkyl chain having from 1 to 6 carbon atoms; —COOH and salts thereof with an organic cation or an inorganic cation; —COOR wherein R is a linear or branched alkyl chain comprising from 1 to 6 carbon atoms; —COF; —CONH₂; —CON(R₁₀₀)(R₁₀₁) wherein each of R₁₀₀ and R₁₀₀ have the same meanings defined for R: —(R)_{c}OH with c being 0 or 1; —C(O)—O—C(O)R;
and the second chain ends of said first and second PFPE chain are bonded to each other via a block of formula (I_{O—O}):
-[A-B—(Rf_{O—O})]_{z}— (I_{O—O})
wherein
z is an integer from 1 to 100,
(A) is a PFPE chain, and
(B) is at least one group of formula (II): 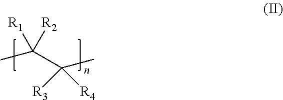
wherein
n is an integer from 1 to 5;
R₁ to R₄, each independently, is selected from the group consisting of, —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms,
X is a functional group; and
b is an integer equal to 1 or 2;
and
wherein
in formula (I_{O—O}), A, B and (Rf_{O—O}) are statistically (randomly) disposed and
the total number of said groups B in said copolymer (P_{O—O}) is from 1 to 100.

15. A block copolymer, copolymer (P_{F—O—O}), wherein the copolymer (P_{F—O—O}) is a copolymer (P_{O—O}) according to claim 13
with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprises a perfluorinated linear or branched alkyl chain having from 1 to 6 carbon atoms or —COF.

16. A mixture, mixture (M2), comprising at least one copolymer (P_{F}) according to claim 11, and at least one of copolymer (P) PFPE peroxy one or more copolymer (P_{O—O}), and/or one or more copolymers (P_{F—O—O}),
wherein
the copolymer (P) is a block copolymer comprising a first and a second perfluoropolyether chain, PFPE chain, each having two chain ends, wherein the first chain end of each one of said first and second PFPE chain is a chain end of copolymer (P) and each one comprises a group selected from a perfluorinated linear or branched alkyl chain comprising from 1 to 6 carbon atoms and —C(═O)F, and the second chain ends of said first and second PFPE chain are bonded to each other via a block of formula (I):
-[A-B]_{z}— (I)
wherein
z is an integer from 1 to 100,
(A) is a PFPE chain, and
(B) is at least one group of formula (II): 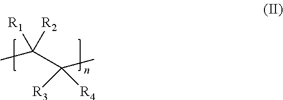
wherein
n is an integer from 1 to 5;
R₁ to R₄, each independently, is selected from the group consisting of, —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms,
X is a functional group; and
b is an integer equal to 1 or 2;
wherein
in said formula (I), said (A) and (B) are statistically (randomly) disposed;
in formula (II), at least one of R₁ to R₄ is group of formula (III); and
the total number of said groups B in said copolymer (P) is from 1 to 100;
the PFPE peroxy is a peroxidic perfluoropolyether polymer having two chain ends, each comprising a group selected from a linear or branched perfluorinated alkyl chain comprising from 1 to 6 carbon atoms or —C(═O)F, said two chain ends being bonded to opposite sides of a perfluoropolyether chain, chain (R_{f}), comprising repeating units (R^{o}) being independently selected from the group consisting of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F:
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain;
the copolymer (P_{O—O}) is a block copolymer comprising a first and a second perfluoropolyether chain, PFPE chain, complying with formula A or (Rf_{O—O}), wherein A is a PFPE chain and (Rf_{O—O}) is a repeating units complying with any one of formulae (i) to (v):
(i) —CFXO—, wherein X is —F or —CF₃;
(ii) —CFXCFXO—, wherein X, equal or different at each occurrence, is —F or —CF₃, with the proviso that at least one of X is —F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain;
and having a peroxidic content (PO), defined as grams of active oxygen (Mw=16) in 100 g of PFPE peroxy between 0.1 and 4, each of said first and second PFPE chain having two chain ends, wherein the first chain end of each one of said first and second PFPE chain is a chain end of copolymer (P) and each one comprises a group selected from: a perfluorinated linear or branched alkyl chain having from 1 to 6 carbon atoms; —COOH and salts thereof with an organic cation or an inorganic cation; —COOR wherein R is a linear or branched alkyl chain comprising from 1 to 6 carbon atoms; —COF: —CONH₂; —CON(R₁₀₀)(R₁₀₁) wherein each of R₁₀₀ and R₁₀₀ have the same meanings defined for R; —(R)_{c}OH with c being 0 or 1; —C(O)—O—C(O)R;
and the second chain ends of said first and second PFPE chain are bonded to each other via a block of formula (I_{O—O}):
-[A-B—(Rf_{O—O})]_{z}— (I_{O—O})
wherein
z is an integer from 1 to 100,
(A) is a PFPE chain, and
(B) is at least one group of formula (II): 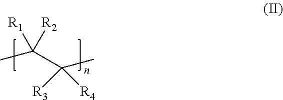
wherein
n is an integer from 1 to 5;
R₁ to R₄, each independently, is selected from the group consisting of, —F, perfluorinated linear or branched alkyl chain having from 1 to 6 carbon atoms, and group of formula (III):
—R₁₀—(X)_{b} (III)
wherein
R₁₀ is a linear or branched perfluoroalkyl chain comprising from 1 to 12 carbon atoms,
X is a functional group; and
b is an integer equal to 1 or 2;
and,
wherein
in formula (I_{O—O}), A, B and (Rf_{O—O}) are statistically (randomly) disposed and
the total number of said groups B in said copolymer (P_{O—O}) is from 1 to 100; and
the copolymer (P_{F—O—O}) is a copolymer (P_{O—O}) with the proviso that (i) at least one chain end of said first and second PFPE chain comprises a group different from a perfluorinated linear or branched alkyl chain having from 1 to 6 carbon atoms and (ii) when one chain end comprises group —COF, the other chain end does not comprises a perfluorinated linear or branched alkyl chain having from 1 to 6 carbon atoms or —COF.

17. The copolymer (P) according to claim 1, wherein R₁₀ is a linear or branched perfluoroalkyl chain comprising from 1 to 12 carbon atoms and containing at least one oxygen atom.

18. The copolymer (P) according to claim 1, wherein X is a functional group selected from: —COOH, —COF, —CN, —Br and —CONH₂.

19. A process, process (P), for the manufacture of mixture (P) according to claim 8, said process comprising
(a) contacting:
at least one perfluoropolyether polymer comprising peroxidic groups, PFPE peroxy;
at least one perfluorinated compound of formula (X-p): 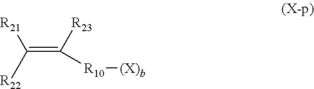
wherein
each of R₂₁ to R₂₃ is independently-F or perfluorinated linear or branched alkyl chain having from 1 to 6 carbon atoms,
R₁₀ is a linear or branched perfluoroalkyl chain comprising from 1 to 12 carbon atoms,
X is a functional group selected from: —COOH, —COF, —CN, —Br and —CONH₂;
b is an integer equal to 1 or 2; and
(b) letting said PFPE peroxy and said compound of formula (X-p) react in the presence of UV radiation or under heating.
